(19) United States
(12) Patent Application Publication
(10) Pub. No.: US 2002/0085795 A1
(43) Pub. Date: Jul. 4, 2002

(54) Optical device

(76) Inventors: Charles D. Carr, Orefield, PA (US); Lu Fang, Orefield, PA (US); Michael Hahn, Allentown, PA (US); Dhiraj H. Malkani, Breinigsville, PA (US)

Correspondence Address: AGERE SYSTEMS INC., P. O. Box 614, Berkeley Heights, NJ, 07922-0614, US

(21) Appl. No.: 09/752,787

(22) Filed: Jan. 2, 2001

(51) Int. Cl. G02B 6/35

(52) U.S. Cl. 385/18

(57) ABSTRACT

The invention is an optical device such as a switch which includes a first module with a first housing, and a first array of rotatable mirrors mounted within the housing and adapted to deflect incoming light beams to a plurality of output locations. The switch also includes a second module with a second housing, and a second array of rotatable mirrors mounted within the second housing and adapted to deflect incoming light beams to a plurality of output locations. The modules are positioned so that at least one incoming beam in the first module directed to the first array can be deflected to an array of the second module.

### FIELD OF THE INVENTION

This invention relates to optical devices such as switches.

### BACKGROUND OF THE INVENTION

The field of optical networks has recently gained considerable interest in telecommunications primarily due to their huge information handling capacity. One area of particular interest is the ability to provide switching of optical signals onto different paths without the need for converting to electrical signals. One approach to producing such switching is to provide an array of rotatable mirrors on a silicon substrate in a micro-electromechanical system (MEMS). These mirrors can be rotated in response to an electrical bias to direct an incoming optical signal to a chosen output fiber. (See, e.g., Hecht, “All Optical Networks Need All Optical Switches,” Laser Focus World, pp. 189-196 (May 2000).)

A single MEMS switch in one design currently provides a switching capacity of 16 ×16 channels. In cases where it is desirable to produce larger switching capacity (typically 128 ×128 channels or greater), a plurality of such devices are usually coupled together by optical fibers in a Clos architecture. See, e.g., Clos, “A Study Of Nonblocking Switching Networks,” Bell System Technical Journal, Vol. 32, pp. 4206-424 (1953). While adequate, such an architecture typically requires a large number of switches (e.g., 48) and is, therefore, an expensive solution. An alternative is to make the array bigger, but this would require new designs for each size switch which would also be costly.

It is desirable, therefore to provide a low cost, high capacity optical switch.

### SUMMARY OF THE INVENTION

The invention is an optical device which includes a first module comprising a first housing, and a first array of rotatable mirrors mounted within the housing and adapted to deflect incoming light beams to a plurality of output locations. The device also includes a second module comprising a second housing, and a second array of rotatable mirrors mounted within the second housing and adapted to deflect incoming light beams to a plurality of output locations. The modules are positioned so that at least one incoming beam in the first module directed to the first array can be deflected to the second module.

### BRIEF DESCRIPTION OF THE FIGURES

These and other features of the invention are delineated in detail in the following description. In the drawing:

FIG. 1 is a perspective view of a module in accordance with an embodiment of the invention; and

FIG. 2 is a perspective view of a plurality of modules mounted in accordance with an embodiment of the invention.

### DETAIL DESCRIPTION

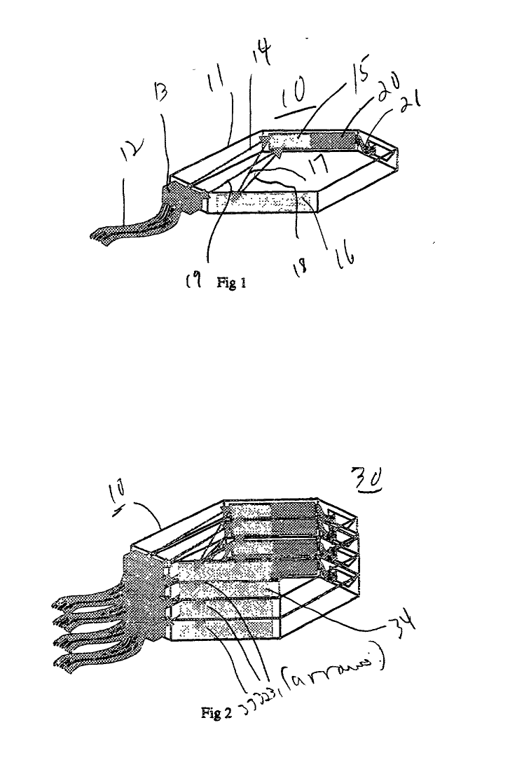

FIG. 1 illustrates a switch module, 10, which includes features of the invention. The module includes a housing, 11, which can be a material such as stainless steel. A plurality of optical fibers, 12, are mounted to one surface of the housing through a commercially available fiber array connector, 13. The fibers are mounted so that input beams, such as the one illustrated by arrow, 14, will be incident on an array of rotatable mirrors, illustrated by block, 15, mounted on another surface of the housing. The array, 15, can be the standard types of Micro-electromechanical Systems (MEMS) mirror devices formed on a silicon substrate, such as the “pop-up” variety (see, e.g., Lin et al, “On the Expandability of Free-Space Micromachined Optical Cross Connects,” Journal of Lightwave Technology, vol. 18, pp 482-489 (April 2000) and Lin et al, “Free-Space Micromachined Optical Switches for Optical Networking,” IEEE Journal of Selected Topics in Quantum Electronics, vol 5, pp 4-9 (January/February 1999) or the type where the mirrors can rotate about two axes simultaneously (see, e.g., Hecht, “All Optical Networks Need All Optical Switches, Laser Focus World, pp189-196 (May 2000). It should be appreciated that such mirror arrays are only examples of the types of mirrors which can be employed in the present invention. As known in the art, each mirror can be rotated by applying a bias to selected conductors (not shown) in the array by means of standard integrated circuitry, illustrated by block 20. Electrical connection of the circuitry to a power source or other circuitry outside the module can be provided by wires, 21.

In this particular embodiment, the array, 15, is mounted so that the input beams, e.g., 14, are deflected by corresponding rotating mirrors to another mirror, 16, mounted on yet another surface of the housing, the deflected beam illustrated by arrow 17. The mirror, 16, can be a flat or curved mirror or an array of rotatable mirrors similar to or identical to array 15. The mirror, 16, is mounted to direct the deflected beams, e.g., 17, back to a desired rotating mirror in the array, 15, one redirected beam illustrated as arrow 18. The redirected beams, e.g., 18, are then deflected by the chosen rotating mirror to a corresponding output fiber in the fiber array, 12, one of said beams illustrated by arrow 19.

It will be appreciated that other types of arrangements can be used in the present invention. For example, separate arrays of input and output fibers could be employed and the need for mirror 16 eliminated.

It will be noted that the interior of the housing, 11, is mostly free space, and that the module does not include a bottom or a cover. These features facilitate vertical stacking of several modules such as illustrated in FIG. 2. The switch, 30, therefore, includes a plurality of modules (in this example four) which are similar or identical to module, 10. A desirable advantage of the switch in FIG. 2 is that light switching is not limited to that between input and output fibers in a single module, as previously described with reference to FIG. 1. Rather, due to the open space within the housing modules, light can be switched between fibers in any modules. For example, arrows 31, 32, and 33, illustrate light deflection from a mirror array, e.g., 15, in one module, 10, to a mirror, e.g., 34, located in the module in an adjacent level. This feature greatly expands the capacity of the switch without having to produce larger mirror arrays or to couple a great number of switches together by optical fibers. In one example, a 128 ×128 switch can be produced using only four modules each with a 32 rotating mirror array (15) as shown in FIG. 2, as compared to 48 switches which would be needed for a Clos architecture. Similarly, a 512 ×512 switch could be produced using 16 modules as compared with 96 switches needed for a Clos architecture.

Various modifications of the described embodiment are possible. For example, the modules need not be stacked in a vertical configuration. Other possibilities include mounting the modules to a spherical surface so that light from one module could be incident on another module. Rather than providing free space in each module, it may be possible to fill the modules with an index-matching fluid. It may also be advantageous in certain applications to provide a single array of fibers such as 12 in a single module, rather than arrays in each module as shown.

Finally, the inventive principles could be used to make optical devices other than switches, such as multiplexers/demultiplexers.

What is claimed is:

1. An optical device comprising:
a first module including a first housing and a first array of rotatable mirrors mounted within the housing and adapted to deflect incoming light beams to a plurality of output locations; and
a second module including a second housing and a second array of rotatable mirrors mounted within the second housing and adapted to deflect incoming light beams to a plurality of output locations, the modules being positioned so that at least one incoming beam in the first module directed to the first array can be deflected to the second module.

2. The device according to claim 1 wherein the interior of the housings is primarily free space

3. The device according to claim 1 wherein the modules are stacked in a vertical direction.

4. The device according to claim 1 wherein there is no surface separating the two modules.

5. The device according to claim 1 wherein each module also includes an additional mirror which is optically coupled to corresponding mirrors in the first and second arrays.

6. The device according to claim 1 wherein the device includes at least four modules each with a housing and an array of rotatable mirrors, at least two modules including neither a cover nor bottom surface.

7. The device according to claim 6 wherein the device is a switch with a capacity of at least 128×128.

8. The device according to claim 1 wherein at least one module also includes an array of optical fibers mounted to the housing.

9. The device according to claim 1 wherein the incoming beam in the first module is deflected to the second array of rotatable mirrors.

10. The device according to claim 8 wherein each module includes an array of optical fibers and the incoming beam in the first module is deflected to a fiber in the array of the second module.

11. An optical switch comprising:
at least four modules each including a housing with an array of rotatable mirrors mounted on one wall of the housing, an additional mirror mounted on another wall of the
